(19) United States
(12) Patent Application Publication
(10) Pub. No.: US 2014/0033096 A1
(43) Pub. Date: Jan. 30, 2014

(54) ELECTRONIC DEVICE AND METHOD FOR ARRANGING TOOLBAR ON USER INTERFACE OF THE ELECTRONIC DEVICE

(71) Applicant: HON HAI PRECISION INDUSTRY CO., LTD., New Taipei (TW)

(72) Inventors: HSIAO-PING CHIU, New Taipei (TW); HSUEH-TSEN TSAI, New Taipei (TW)

(21) Appl. No.: 13/939,312

(22) Filed: Jul. 11, 2013

(30) Foreign Application Priority Data
Jul. 27, 2012 (TW) 101127087

(51) Int. Cl. G06F 3/0482

(52) U.S. Cl. CPC G06F 3/0482
USPC 715/765

(57) ABSTRACT

In a method for arranging a toolbar on a user interface of an electronic device, the toolbar includes toolbar buttons. The electronic device displays a polyhedral box for arrangement of the toolbar on the user interface. The method divides each surface of the polyhedral box into a plurality of blocks, and moves the toolbar buttons onto the blocks of the polyhedral box. The polyhedral box may be rotated in several planes to reveal all available toolbar buttons, and when a user selects a toolbar button, a function of the toolbar button is triggered.

### BACKGROUND

1. Technical Field

The present disclosure relates to software interfaces of electronic devices, and more particularly to an electronic device and method for arranging a toolbar on a user interface of the electronic device.

2. Description of Related Art

Toolbars are displayed in columns or rows on a user interface of application software that is executed by an electronic device. The application software may be a text file (for example, a WORD file), or a drawing software, for example. A toolbar includes many toolbar buttons. However, a number of toolbar buttons displayed on the user interface of the application software is limited. In this case, when a toolbar button that does not display on the user interface of the application software is needed, the toolbar button is searched for from hidden toolbar options of the application software. A search action may result in being inconvenient and time wasting. Therefore, there is room for improvement in the art.

### BRIEF DESCRIPTION OF THE DRAWINGS

FIG. 1 is a block diagram of one embodiment of an electronic device including a toolbar arranging system.

FIG. 2 is a block diagram of function modules of the toolbar arranging system included in the electronic device.

FIG. 3 is a flowchart of one embodiment of a method for arranging a toolbar on a user interface of the electronic device of FIG. 1.

FIG. 4A is a schematic diagram of a closed cube used to arrange the toolbar, and

FIG. 4B is a schematic diagram of the closed cube which has been opened, and used to arrange the toolbar.

FIG. 5 is a schematic diagram of the closed cube containing operating toolbar buttons of the toolbar.

FIG. 6 is a schematic diagram of the opened cube that contains operating toolbar buttons of the toolbar.

FIG. 7 is a schematic diagram of the closed cube that completes the arrangement of toolbar buttons of the toolbar.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In general, the word module, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable storage medium or other storage system. The non-transitory computer-readable storage medium may include CDs, DVDs, BLU-RAY, flash memory, and hard disk drives.

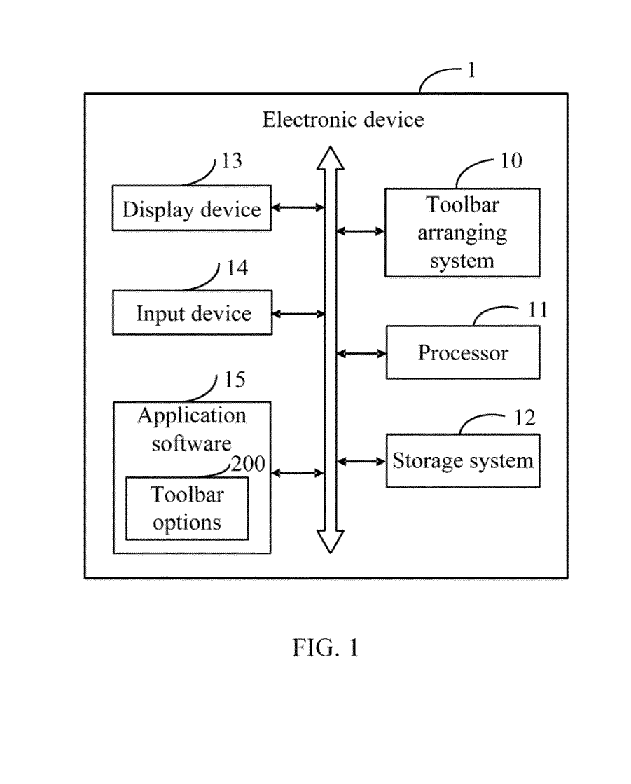

FIG. 1 is a block diagram of one embodiment of an electronic device 1 including a toolbar arranging system 10. In the embodiment, the electronic device 1 may be a mobile phone, a notebook computer, or a personal digital assistant (PDA), for example. The toolbar arranging system 10 can be used to display a polyhedral box on a user interface of the electronic device 1, and arrange toolbar buttons of a toolbar on the polyhedral box. The polyhedral box may be a polyhedron, for example, a pyramid, a cube, or a solid figure with multiple surfaces, such as seven or more surfaces. In one embodiment, each surface of the polyhedral box is divided into a plurality of blocks. Each block of the polyhedral box contains a toolbar button of the toolbar that is moved onto the polyhedral box by a user.

The electronic device 1 includes a display device 13, an input device 14, and application software 15. The display device 13 displays the polyhedral box on the user interface of the electronic device 1. The input device 14 receives operations of the user, for example, the moving of toolbar buttons of the toolbar onto the blocks of the polyhedral box. The application software 15 generates a user interface that includes one or more toolbars. In one embodiment, the application software 15 may be a text file (for example, a WORD file, or an EXCEL file), or a drawing software, for example. The toolbar includes one or more toolbar options 200, each of the toolbar options 200 includes one or more toolbar buttons that are moved onto the blocks of the polyhedral box.

The electronic device 1 further includes at least one processor 11 and a storage system 12. In one embodiment, the storage system 12 may be an internal storage system, such as a random access memory (RAM) for temporary storage of information, and/or a read only memory (ROM) for permanent storage of information. In some embodiments, the storage system 12 may also be an external storage device, such as an external hard disk, a storage card, or a data storage medium. The at least one processor 11 executes one or more computerized codes and other applications of the electronic device 1 to provide the functions of the toolbar arranging system 10.

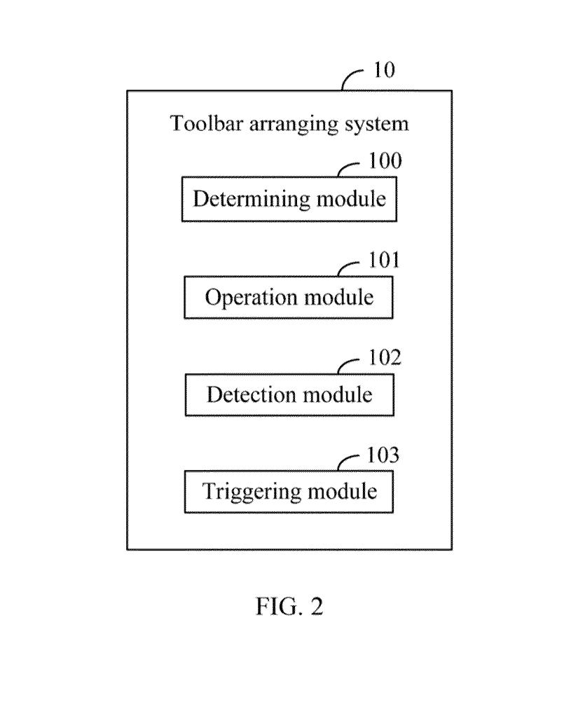

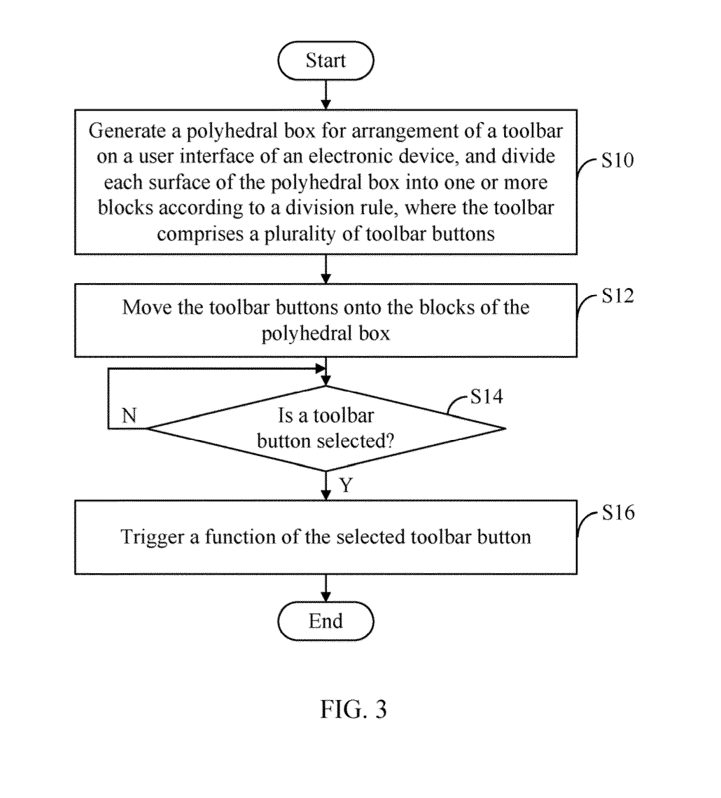

FIG. 2 is a block diagram of function modules of the toolbar arranging system 10 included in the electronic device 1. In one embodiment, the toolbar arranging system 10 may include a determining module 100, an operation module 101, a detection module 102, and a triggering module 103. The modules 100-103 comprise computerized codes in the form of one or more programs that are stored in the storage system 12 of the electronic device 1. The computerized codes include instructions that are executed by the at least one processor 11 of the electronic device 1 to provide functions for the modules. Details of each of the modules are given in FIG. 3.

FIG. 3 is a flowchart of one embodiment of a method for arranging a toolbar on a user interface of the electronic device 1 of FIG. 1. Depending on the embodiment, additional steps may be added, others deleted, and the ordering of the steps may be changed.

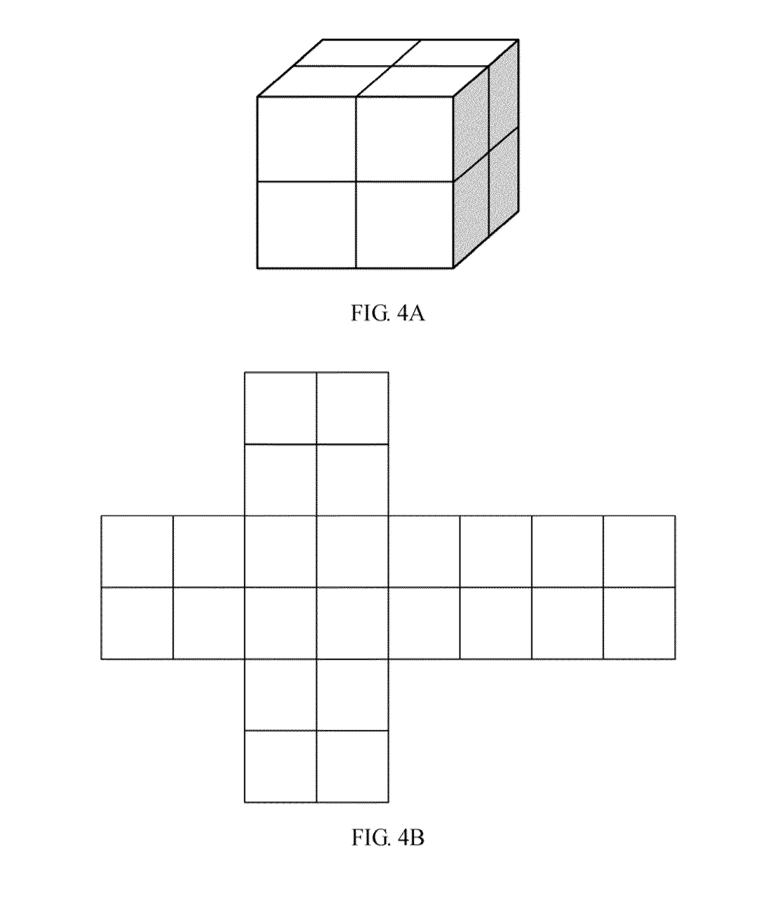

In step S10, the determining module 100 generates and displays a polyhedral box for arrangement of the toolbar on the user interface, and divides each surface of the polyhedral box into a plurality of blocks according to a division rule determined by the user. The division rule is defined as a rule that determines the number of blocks on each surface of the polyhedral box. The polyhedral box may be a polyhedron, for example, a pyramid, a cube, or a solid figure with multiple surfaces, such as seven or more surfaces. As shown in FIG. 4A, the polyhedral box is a cube, and the division rule divides each surface of the cube into four blocks, allowing for a total of twenty four blocks. The toolbar includes one or more toolbar options 200, each of the toolbar options 200 includes one or more toolbar buttons that are moved onto the blocks of the polyhedral box.

In step S12, the operation module 101 moves toolbar buttons of the toolbar options 200 onto the blocks of the polyhedral box. The toolbar buttons are moved onto the blocks of the polyhedral box from toolbar options 200 of the software application 15. Each block of the polyhedral box can contain a single toolbar button. In one embodiment, the toolbar buttons are placed on the blocks of the polyhedral box in the form of hyperlinks.

In one embodiment, the user may drag the toolbar buttons from the toolbar options 200 onto the blocks of the polyhedral box, or copy the toolbar buttons from the toolbar options 200 and paste the toolbar buttons onto the blocks of the polyhedral box, for example. The polyhedral box may be a closed polyhedron, or an opened polyhedron that the closed polyhedron has been opened. For example, FIG. 4A is a closed cube, and FIG. 4B shows an opened cube that the closed cube of FIG. 4A has been opened.

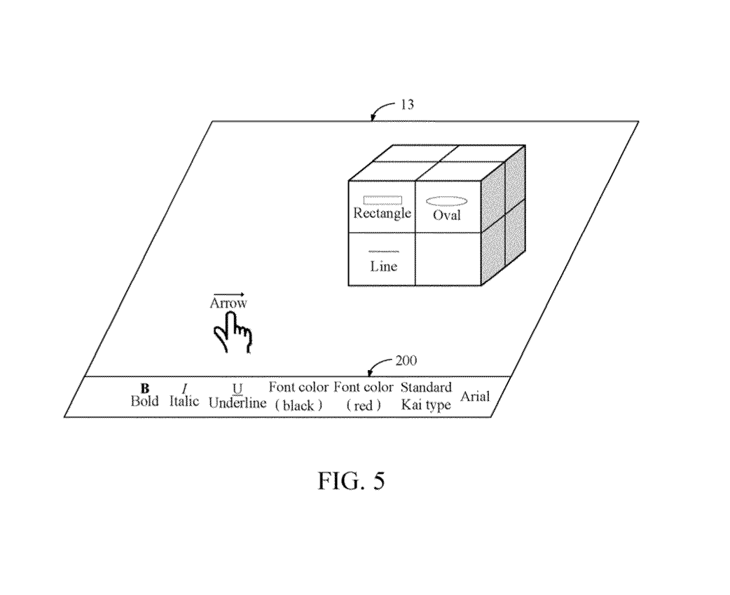

If the polyhedral box is the closed polyhedron, the closed polyhedron includes substantially face-on surfaces and shaded or obscured surfaces. The face-on surface is defined as a surface that faces eyes of the user, for example, an upper surface of the closed polyhedron, a right surface of the closed polyhedron, or a front surface of the closed polyhedron. The shaded or obscured surface is defined as a surface that is largely invisible, or insufficiently defined, to the user, for example, a lower surface of the closed polyhedron, a left surface of the closed polyhedron, or a back surface of the closed polyhedron. When a toolbar button is moved onto a block of a face-on surface, the operation module 101 moves the toolbar button onto the block of the face-on surface by the user directly. As shown in FIG. 5, a toolbar button is dragged from the toolbar options 200 onto the closed cube of FIG. 4A. When a toolbar button is required to be moved onto a block of a shaded or obscured surface, the operation module 101 rotates the required surface to the front surface of the closed polyhedron, rendering it substantially face-on, and moves the toolbar button onto the block of the required surface by the user.

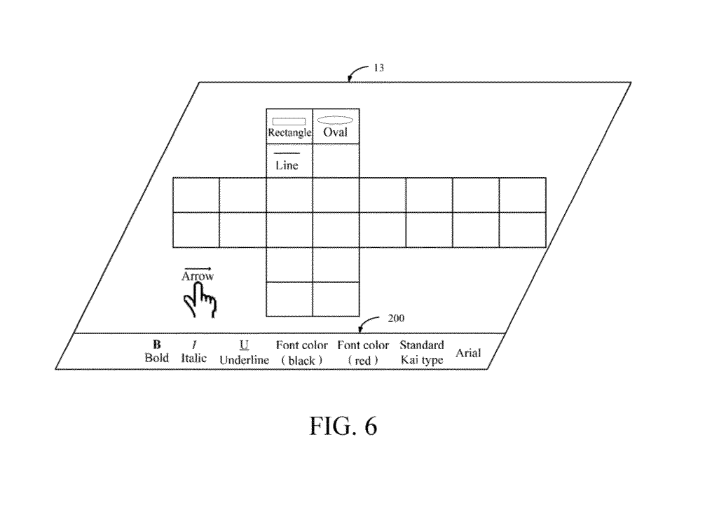

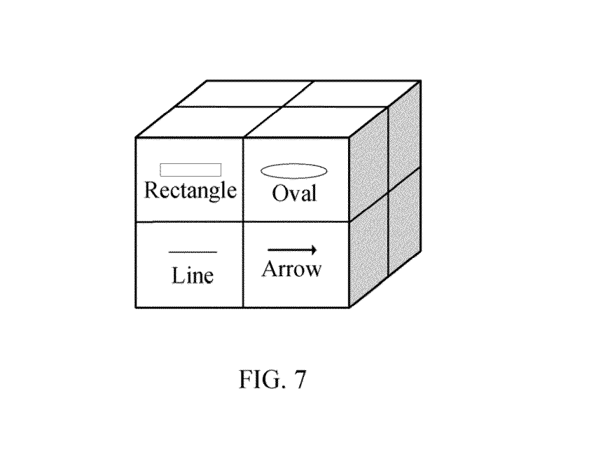

If the polyhedral box is the opened polyhedron, when a toolbar button is moved onto a block of the opened polyhedron, the operation module 101 moves the toolbar button onto the block of the opened polyhedron, and then controls the opened polyhedron to close, to appear as the closed polyhedron. As shown in FIG. 6, a toolbar button is dragged from the toolbar options 200 onto the opened cube of FIG. 4B. After the arrangement of the toolbar is completed, the display device 13 displays the closed polyhedron. As shown in FIG. 7, the toolbar buttons are displayed in a closed cube.

In step S14, the detection module 102 detects whether a toolbar button is selected by the user. If the toolbar button is selected, step S16 is implemented. If the toolbar button is not selected, step S14 is repeated.

In step S16, the triggering module 103 triggers the function of the selected toolbar button. In one embodiment, the triggering module 103 triggers the function of the selected toolbar button according to the hyperlink of the selected toolbar button. For example, if the “Arrow” tool of FIG. 7 is selected by the user, then the user can draw an arrow on the application software 15 by using the “Arrow” tool.

In this disclosure, the toolbar buttons are displayed on the polyhedral box. The polyhedral box can carry many toolbar buttons on the blocks of each surface of the polyhedral box. It is convenient to display many toolbar buttons in a small area. The user can arrange common toolbar buttons that are usually used by the user to the polyhedral box. Time is not wasted by searching for hidden toolbar buttons and convenience for the user is enhanced.

The described embodiments are merely possible examples of implementations, and have been set forth for a clear understanding of the principles of the present disclosure. Many variations and modifications may be made without departing substantially from the spirit and principles of the present disclosure. All such modifications and variations are intended to be included within the scope of this disclosure and the described inventive embodiments, and the present disclosure is protected by the following claims.

What is claimed is:

1. A computerized-method for arranging a toolbar on a user interface of an electronic device, the method comprising steps of:
generating a polyhedral box for arrangement of the toolbar on the user interface, wherein the toolbar comprises a plurality of toolbar buttons;
dividing each surface of the polyhedral box into one or more blocks according to a division rule that is determined by a user;
moving the toolbar buttons onto the blocks of the polyhedral box; and
triggering a function of a toolbar button when the toolbar button is selected by the user.

2. The method as claimed in claim 1, wherein the polyhedral box is a polyhedron including a pyramid, a cube, and a solid figure with multiple surfaces.

3. The method as claimed in claim 1, wherein the toolbar buttons are placed on the blocks of the polyhedral box in the form of hyperlinks.

4. The method as claimed in claim 1, wherein the polyhedral box is a closed polyhedron or an opened polyhedron that the closed polyhedron has been opened.

5. The method as claimed in claim 4, wherein the moving step comprises:
when a toolbar button is moved onto a block of a face-on surface of the closed polyhedron, moving the toolbar button onto the block of the face-on surface by the user directly; or
when a toolbar button is required to be moved onto a block of a shaded or obscured surface of the closed polyhedron, rotating the required surface to the front surface of the closed polyhedron, and moving the toolbar button onto the block of the required surface by the user.

6. The method as claimed in claim 4, wherein the moving step comprises:
when a toolbar button is moved onto a block of the opened polyhedron, moving the toolbar button onto the block of the opened polyhedron, and controlling the opened polyhedron to close, to appear as the closed polyhedron.

7. A non-transitory computer readable storage medium storing a set of instructions that, when executed by at least one processor of an electronic device, causes the at least one processor to perform a method for arranging a toolbar on a user interface of the electronic device, the method comprising steps of:
generating a polyhedral box for arrangement of the toolbar on the user interface, wherein the toolbar comprises a plurality of toolbar buttons;
dividing each surface of the polyhedral box into one or more blocks according to a division rule that is determined by a user;
moving the toolbar buttons onto the blocks of the polyhedral box; and
triggering a function of a toolbar button when the toolbar button is selected by the user.

8. The storage medium as claimed in claim 7, wherein the polyhedral box is a polyhedron including a pyramid, a cube, and a solid figure with multiple surfaces.

9. The storage medium as claimed in claim 7, wherein the toolbar buttons are placed on the blocks of the polyhedral box in the form of hyperlinks.

10. The storage medium as claimed in claim 7, wherein the polyhedral box is a closed polyhedron or an opened polyhedron that the closed polyhedron has been opened.

11. The storage medium as claimed in claim 10, wherein the moving step comprises:
when a toolbar button is moved onto a block of a face-on surface of the closed polyhedron, moving the toolbar button onto the block of the face-on surface by the user directly; or
when a toolbar button is required to be moved onto a block of a shaded or obscured surface of the closed polyhedron, rotating the required surface to the front surface of the closed polyhedron, and moving the toolbar button onto the block of the required surface by the user.

12. The storage medium as claimed in claim 10, wherein the moving step comprises:
when a toolbar button is moved onto a block of the opened polyhedron, moving the toolbar button onto the block of the opened polyhedron, and controlling the opened polyhedron to close, to appear as the closed polyhedron.

13. An electronic device, comprising:
at least one processor; and
a computer-readable storage medium storing one or more programs, which when executed by the at least one processor, causes the at least one processor to:
generate a polyhedral box for arrangement of a toolbar on a user interface of the electronic device, wherein the toolbar comprises a plurality of toolbar buttons;
divide each surface of the polyhedral box into one or more blocks according to a division rule that is determined by a user;
move the toolbar buttons onto the blocks of the polyhedral box; and
trigger a function of a toolbar button when the toolbar button is selected by the user.

14. The electronic device as claimed in claim 13, wherein the polyhedral box is a polyhedron including a pyramid, a cube, and a solid figure with multiple surfaces.

15. The electronic device as claimed in claim 13, wherein the toolbar buttons are placed on the blocks of the polyhedral box in the form of hyperlinks.

16. The electronic device as claimed in claim 13, wherein the polyhedral box is a closed polyhedron or an opened polyhedron that the closed polyhedron has been opened.

17. The electronic device as claimed in claim 16, wherein the toolbar buttons are moved onto the blocks of the polyhedral box by performing steps of:
when a toolbar button is moved onto a block of a face-on surface of the closed polyhedron, moving the toolbar button onto the block of the face-on surface by the user directly; or
when a toolbar button is required to be moved onto a block of a shaded or obscured surface of the closed polyhedron, rotating the required surface to the front surface of the closed polyhedron, and moving the toolbar button onto the block of the required surface by the user.

18. The electronic device as claimed in claim 16, wherein the toolbar buttons are moved onto the blocks of the polyhedral box comprises by performing steps of:
when a toolbar button is moved onto a block of the opened polyhedron, moving the toolbar button onto the block of the opened polyhedron, and controlling the opened polyhedron to close, to appear as the closed polyhedron.
